(19) United States
(12) Patent Application Publication
(10) Pub. No.: US 2025/0110489 A1
(43) Pub. Date: Apr. 3, 2025

(54) MULTIPLE EMULATION MODEL SYNCHRONIZATION

(71) Applicant: Rockwell Automation Technologies, Inc., Mayfield Heights, OH (US)

(72) Inventors: Roger D. Kassouf, Jr., Brecksville, OH (US); Simon Blackwell, Kiln Farm (GB); Andrew Deeble, Reading (GB)

(21) Appl. No.: 18/905,756

(22) Filed: Oct. 3, 2024

Related U.S. Application Data
(60) Provisional application No. 63/587,634, filed on Oct. 3, 2023.

(51) Int. Cl. G05B 19/418

(52) U.S. Cl. CPC G05B 19/41885; G05B 19/4185

(57) ABSTRACT

Disclosed are systems and methods for synchronizing emulation models (i.e., digital twins) of portions of industrial automation systems across distributed computing systems. The emulation models are configured with sending and receiving nodes, and a publish and subscriber networking protocol is used to transmit loads between the nodes. A communication broker (i.e., multi-model server) configures a load transmission graph using the nodes of the emulation models and brokers the transmissions of loads based on the load transmission graph to ensure that loads published from a sending node are sent to the receiving node. As such, the emulations on the distributed node depict loads moving from sending nodes of one model to the corresponding receiving nodes in another model in near-real time.

### CROSS REFERENCE TO RELATED APPLICATIONS

This application claims priority to and the benefit of U.S. Provisional Patent Application No. 63/587,634, titled “MULTIPLE EMULATION MODEL SYNCHRONIZATION,” filed Oct. 3, 2023, the contents of which is incorporated herein by reference in its entirety for all purposes.

### TECHNICAL FIELD

Various embodiments of the present technology relate to industrial automation environments using emulation models and particularly to load balancing synchronization for digital twin models.

### BACKGROUND

Digital twin models for use in industrial automation are constrained in performance and scale. Typical constraints include the amount of computing resources available to the computing machines running the modelling software application, the implementation of the software itself to take full advantage of the resources available, or both. Simulation software products often make tradeoffs between design implementation complexity, simulation accuracy and fidelity, system scale, and simulation time scale. For example, a simulation which is highly accurate for complex physical domains may not be scalable in the scope of the larger system. Likewise, large-scale system simulations often have very simplified component models to improve overall execution efficiency. Simulation execution time can vary from fractions of a second to days or weeks.

Digital twin systems often need to synchronize with physical assets operating near real-time, which is the time scale of the real world for this purpose. This need to synchronize puts a clear constraint on both the scale of the digital representation being simulated as well as the fidelity and scale of that model. Calculations to evolve the state of the simulated system must be performed in a shorter time than the next time-step. Further, the synchronization aspect adds additional overhead processing to the machine running the simulation.

Due to these tradeoffs, emulation or simulation of a large digital twin system is not available. A single machine is constrained in resources and may not be able to simulate or emulate the entire large system with the available computing resources. Further, while a large system can be broken into smaller model portions for execution on differing machines, the transmission of data between the portions is not available.

Prior systems include Hardware-in-the-loop (HIL) system emulators that allow a real-time digital representation of the modeled system. However, HIL systems are dedicated, costly, and use arcane hardware. While software can run the models to perform the simulation, the software instances are disconnected, so the data is not easily transmitted between models. Accordingly, improved systems are needed to account for large system emulation and simulation.

### SUMMARY

The present disclosure provides technology to synchronize individual models (portions of a large system model) and intelligently transmit “loads” (e.g., products being made by the industrial automation process) or other data between models. Digital twin modelers can represent very large systems by splitting their abstract representation of the system into smaller models. These smaller models can fully utilize the computing resources of a single machine without being too large to run out of resources.

The modeler can specify valid connection points (e.g., sending nodes and receiving nodes) within each model and expose the models to a centralized server (e.g., pub/sub broker) for communications. The server ingresses the connection points from each model to create an abstract representation (e.g., block diagram) of each model. The modeler can wire valid connections between the models on the centralized server, thus specifying the routes for the data to flow in. The server synchronizes the running state of the models and acts as the data broker for the publishing and subscription of the data between the models.

The modeling software may be incorporated into emulation software, simulation software, or a combination. An example of the modeling software is EMULATE3D created by ROCKWELL AUTOMATION.

As described in further detail in the detailed description, a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of distributed emulation model synchronization. A communication broker may perform the method. The communication broker may configure a load transmission graph that includes a link between a sending node and a receiving node, where the sending node is hosted in a first emulation model (e.g., digital twin of a portion of an industrial automation process) on a first multi-model client and the receiving node is hosted in a second emulation model (e.g., digital twin of another portion of the industrial automation process) on a second multi-model client. The communication broker may broker the publish and subscribe networking protocol (e.g., Message Queuing Telemetry Transport (MQTT)) to receive published load transmissions from the sending node and transmit the load transmission to the receiving node based on the load transmission graph. Other embodiments of this aspect include corresponding computer systems, apparatus, and computer programs recorded on one or more computer storage devices, each configured to perform the actions of the methods.

Implementations may include one or more of the following features. Optionally, the communication broker or the first multi-model client may generate a user interface that displays the execution of the first emulation model. The communication broker or the second multi-model client may generate another user interface that displays the execution of the second emulation model synchronized with the execution of the first emulation model. In some embodiments, upon transmission of a load by the sending node, the load is visually removed from the first user interface displaying the first emulation model and visually added to the second user interface displaying the second emulation model once the load is received. As such, the user interfaces may depict the load transmitting between models in near-real time (e.g., within less than five seconds).

Optionally, the first emulation model is a digital twin of a first portion of an industrial automation process and the second emulation model is a digital twin of a second portion of the industrial automation process.

Optionally, the communication broker may transmit model control instructions to the first multi-model client and the second multi-model client to synchronize execution of the emulation models. The model control instructions may include a run instruction, a stop instruction, and a reset instruction. Accordingly, the first emulation model and the second emulation model begin executing simultaneously based on receiving the run instruction. They also stop executing simultaneously based on receiving the stop instruction. Both models may reset to an initialized state based on receiving the resent instruction.

Optionally, the communication broker receives a published load transmission of a load from the sending node, which deserializes the published load in the first emulation model upon publishing. The communication broker also transmits the published load transmission of the load to the receiving node, which serializes the received load in the second emulation model upon receiving the published load transmission.

Optionally, the communication broker further receives configuration information from each of the multi-model clients. The configuration information may include information corresponding to the sending node and information corresponding to the receiving node. The communication broker may generate a graphical user interface that includes a configuration dashboard based on the configuration information. Upon receiving user input (e.g., connecting receiving nodes to publishing nodes), the communication broker may configure the load transmission graph based on the user input received via the configuration dashboard.

In some embodiments, there are more than two multi-model clients each hosting an emulation model. Each emulation model may include a digital twin of a portion of the industrial automation process. The load transmission graph may include multiple sending nodes and multiple receiving nodes. The load transmission graph may include connection links such that the sending nodes transmit loads to receiving nodes hosted on different multi-model clients than the multi-model client hosting the sending node. Further, any multi-model client may include any number of sending nodes and/or receiving nodes.

Optionally, the communication broker may use different control modes for transmitting the published load transmissions. For example, the control mode may be unrestricted so that as soon as the communication broker receives the published load transmission, the communication broker transmits the published load transmission to the corresponding receiving node based on the load transmission graph. In some embodiments, the loads are published automatically from the sending node such that when the load reaches a specific point in the process (e.g., the end of a conveyor), the load is transmitted. In some embodiments, the loads are published manually from the sending node such that the loads are transmitted based on a user interaction. Another control mode may include restricted or unrestricted. When load transmission is restricted, they are not transmitted until the restriction conditions are met. For example, receiving nodes may include a congestion zone. When a sending node publishes the load transmission, the communication broker may not transmit the load transmission to the receiving node until the congestion zone is clear of prior loads. Accordingly, the communication broker may hold the published load transmission until the congestion zone is clear and, upon confirming the congestion zone is clear, the communication broker may transmit the published load transmission to the receiving node. Implementations of the described techniques may include hardware, a method or process, or computer software on a computer-accessible medium.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views.

FIG. 1 illustrates an exemplary multi-model synchronization system, according to some embodiments.

FIG. 2A illustrates an example of a dashboard for synchronizing models with a communication broker, according to some embodiments.

FIG. 2B illustrates an exemplary multi-model synchronization system depicting load transmission graph shown in the dashboard of FIG. 2A.

FIG. 3 illustrates an example of user interfaces depicting two synchronized models each representing a portion of an industrial automation system each having a sending and a receiving node at time t1, according to some embodiments.

FIG. 4 illustrates the example of FIG. 3 at time t2.

FIG. 5 illustrates another example of user interfaces depicting two synchronized models each representing a portion of an industrial automation system and configured with an unrestricted manual control mode at time t1, according to some embodiments.

FIG. 6 illustrates the example of FIG. 5 at time t2.

FIG. 7 illustrates yet another example of user interfaces depicting two synchronized models each representing a portion of an industrial automation system and configured with a restricted automatic control mode at time t1.

FIG. 8 illustrates the example of FIG. 7 at time t2.

FIG. 9 illustrates the example of FIG. 7 at time t3.

FIG. 10 illustrates an example dashboard for configuring nodes on a communication broker, according to some embodiments.

FIG. 11 illustrates an example architecture for scaling a large system across multiple multi-model clients, according to some embodiments.

FIG. 12 illustrates different options for digital twin modeling, according to some embodiments.

FIG. 13 illustrates a view of a complex industrial automation system, according to some embodiments.

FIG. 14 illustrates a user interface depicting a digital twin simulation of a portion of the complex industrial automation system of FIG. 13, according to some embodiments.

FIG. 15 illustrates a user interface depicting a digital twin simulation of another portion of the complex industrial automation system of FIG. 13, according to some embodiments.

FIG. 16 illustrates a method for synchronizing multiple model simulation in a distributed environment using a publish and subscribe networking protocol, according to some embodiments.

FIG. 17 illustrates an example computing system used in some embodiments of the present technology.

### DETAILED DESCRIPTION

As discussed above, some industrial automation processes are too vast to be simulated on a single computing device as a single model due to resource constraints of typical computing devices. To overcome some of the issues associated with these constraints, various embodiments of the present technology relate to digital twin models for a single industrial automation process that are distributed across multi-model clients and synchronized to intelligently transmit data between the models.

As discussed herein, a digital twin may be a highly detailed, virtual representation of physical assets, processes, systems, or even entire manufacturing environments, used in industrial automation systems. It combines real-time data, simulation models, machine learning, and analytics to replicate, monitor, and optimize the performance of industrial assets and processes. The term model may be used interchangeably with digital twin throughout.

A distributed system is created using multi-model clients and a multi-model server. On the various multi-model clients, connection points within each model can be specified and exposed to the multi-model server (i.e., connection broker). The connection points may be sending nodes or receiving nodes. The multi-model server ingresses the connection points from each model to create a representation of each model. On the multi-model server, the connection points for each model can be coupled or “wired” to other connection points in other models to specify the routes for the data using a dashboard. For example, a sending node of a first model can be wired to the receiving node of a second model so that the data can be transmitted from the first model to the second model. The transmitted data may represent loads (e.g., products manufactured in the industrial automation process). The multi-model server synchronizes the running state of the models that are running simultaneously, and the multi-model server acts as a data broker (i.e., connection broker) for the publishing and subscription of data between the models using a publish and subscribe networking protocol.

Advantageously, a large system can be emulated in a digital twin environment by breaking the large system into areas or portions of the large system and making a digital twin of each area or portion. Each digital twin can be executed on a different computing device so that the entire large system is emulated using the computing resources of many computing systems simultaneously. By synchronizing the digital twins on each computing device, large systems can be effectively and efficiently emulated, which was previously not possible in many instances.

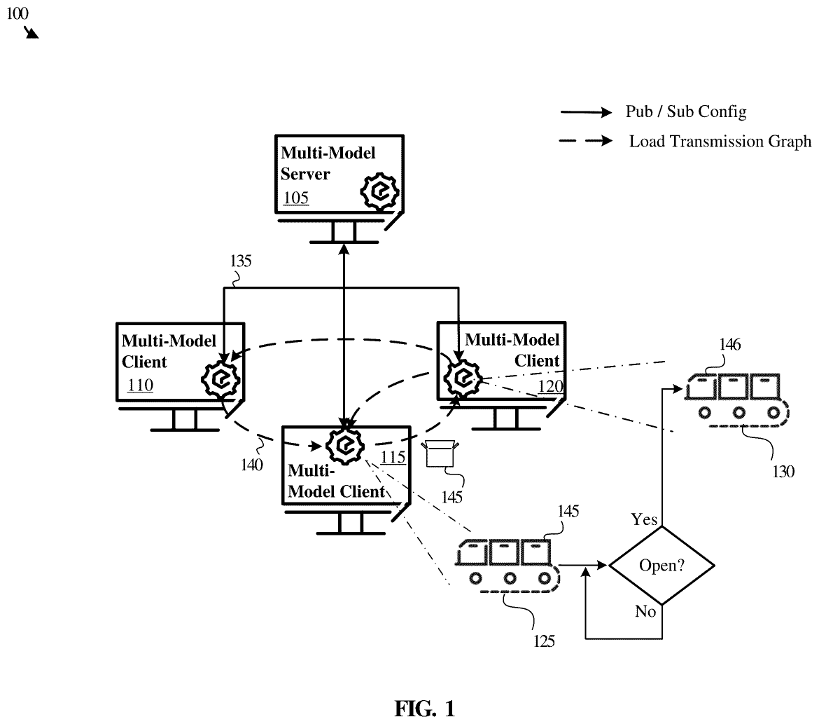

Turning now to the Figures, FIG. 1 illustrates a multi-model synchronization system 100. System 100 includes multi-model server 105, multi-model client 110, multi-model client 115, and multi-model client 120.

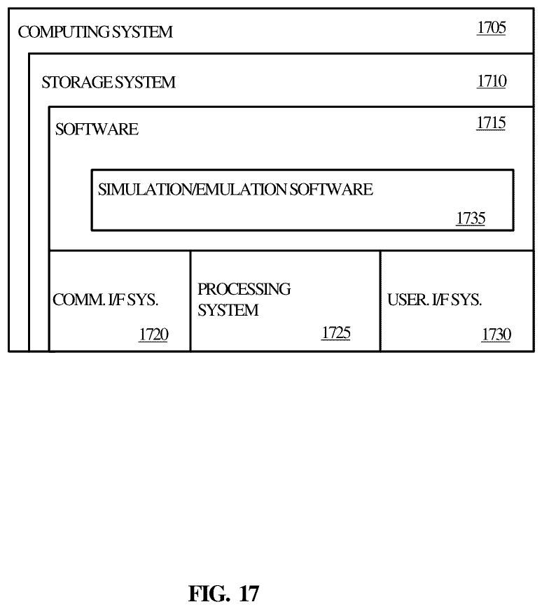

Multi-model server 105 may be any computing device that can function as a multi-model server (e.g., a server computing system, a blade server, a cloud-based system, or the like). For example, multi-model server 105 may be computing system 1700 depicted and described with respect to FIG. 17. Multi-model server 105 serves as the connection broker for the publish and subscribe networking protocol used by system 100. Example publish and subscribe networking protocols include Message Queuing Telemetry Transport (MQTT), Advanced Message Queuing Protocol (AMQP), NATS, Apache Kafka, and GOOGLE Cloud Pub/Sub. The solid connection lines 135 depict the publish and subscribe communication links used for the publish and subscribe networking protocol.

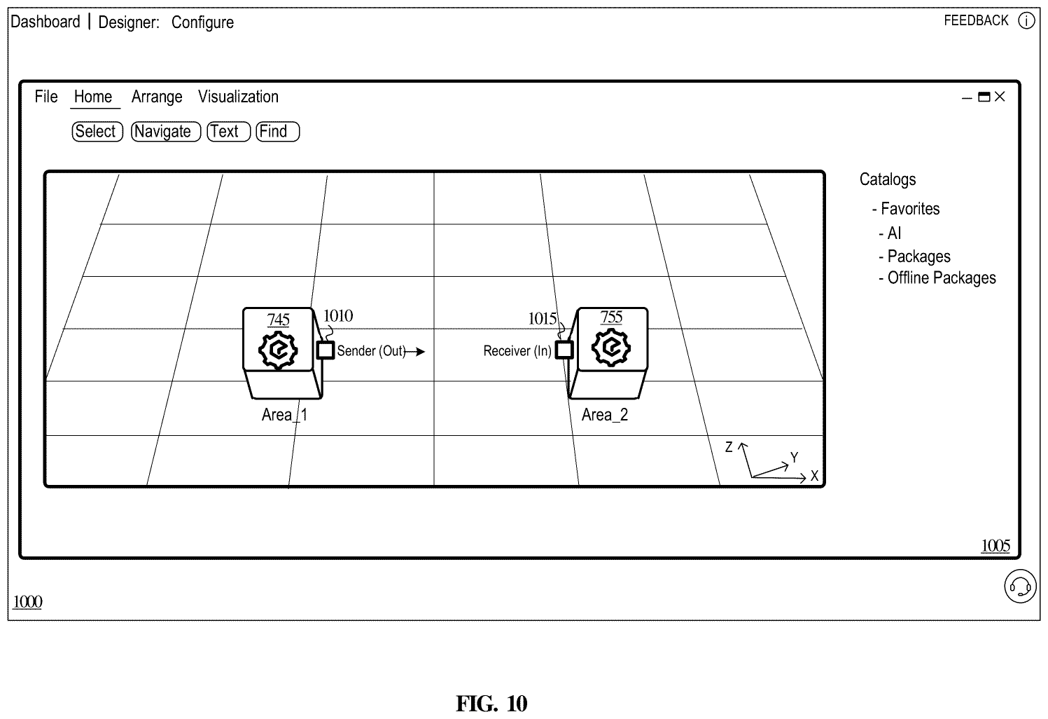

Multi-model server 105 executes a server software application that provides a user interface for configuring system 100 including generating a load transmission graph and for executing system 100 using model controls. A user may access the server software application and create and configure the load transmission graph. The load transmission graph includes the logical connections for transmitting loads between the models on multi-model clients 110, 115, 120. More specifically, models include connection points (i.e., sending nodes and receiving nodes). The load transmission graph includes the logical connections that map the sending nodes to the corresponding receiving nodes such that when a load reaches a sending node, the load transmission graph dictates to which receiving node the load is transmitted. The dashed lines 140 represent the load transmission graph. An example user interface for configuring the load transmission graph is found in FIG. 10 and described in more detail in the accompanying paragraphs.

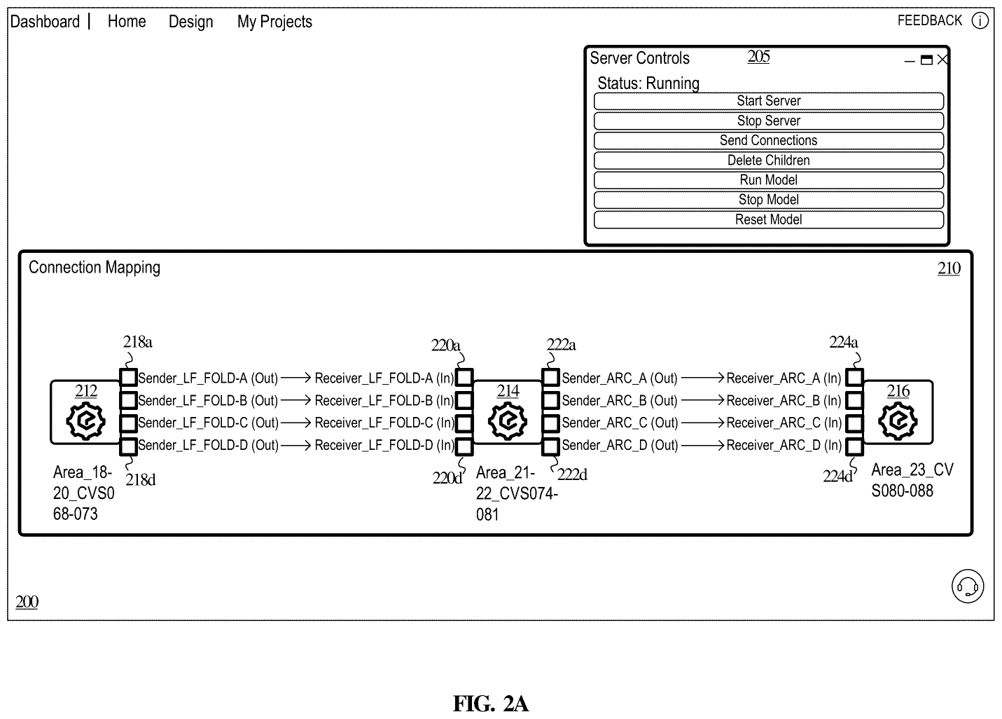

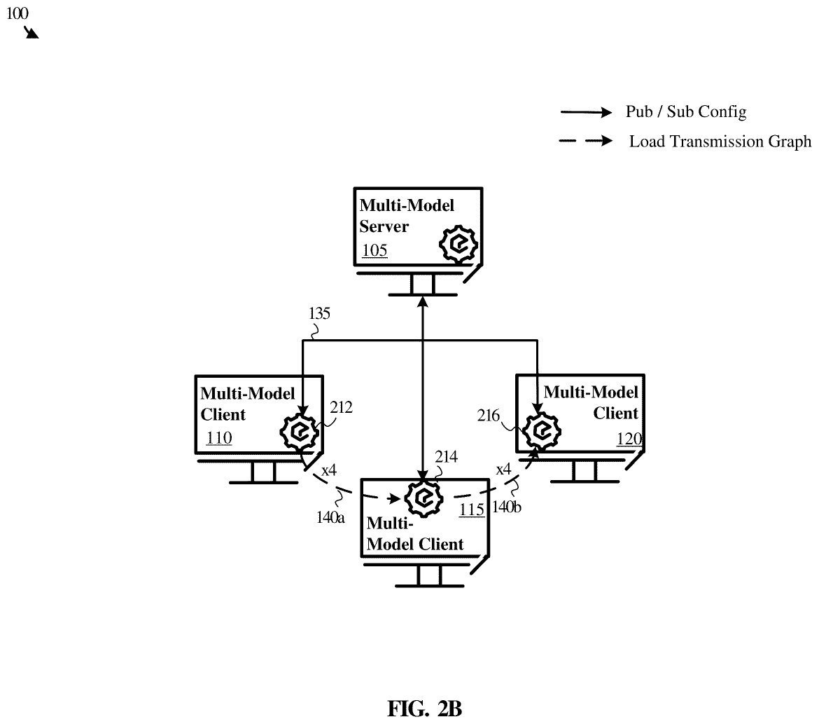

Multi-model server 105 also propagates model controls to multi-model clients 110, 115, 120. The model controls ensure execution synchronization of the distributed models on each of the multi-model clients 110, 115, 120. For example, the model controls dictate when multi-model clients 110, 115, 120 run the models, stop the models, and reset the models, such that each multi-model client 110, 115, 120 receives the model control instructions substantially simultaneously and, therefore, substantially simultaneously executes the model control instructions. An example user interface for synchronizing system 100 from multi-model server 105 is found in FIG. 2 and described in more detail in the accompanying paragraphs.

Multi-model clients 110, 115, 120 may be any computing device that can function as a multi-model client (e.g., a personal computing system, a blade server, a cloud-based system, or the like). For example, multi-model clients 110, 115, 120 may be computing system 1700 depicted and described with respect to FIG. 17. While three multi-model clients 110, 115, 120 are included in system 100, any number of multi-model clients may be included. The number of multi-model clients 110, 115, 120 may be determined based on the number of distributed models needed to model the needed industrial automation process. Multi-model clients 110, 115, 120 each execute a client software application for hosting a digital twin (i.e., model) representing a portion of the industrial automation process.

In use, a modeler can generate the digital twin in the client software application. When modeling, the modeler can specify connection points (e.g., sending nodes and receiving nodes) in the model. Multi-model clients 110, 115, 120 may register as a multi-model client with multi-model server 105, which exposes the connection points of the models on each multi-model client 110, 115, 120 to multi-model server 105.

Once each model is configured on multi-model clients 110, 115, 120 and registered with multi-model server 105, the modeler can configure the load transmission graph on multi-model server 105. The load transmission graph is used by multi-model server 105 to ensure loads are transmitted between the publishing nodes and subscribing nodes of the models on multi-model clients 110, 115, 120 as modeled.

During configuration and execution, each multi-model client 110, 115, 120 communicates with multi-model server 105. For example, depending on the publish and subscribe networking protocol used, each multi-model client 110, 115, and 120 registers with multi-model server 105 and provides its corresponding model connection points and other configuration information. Additionally, multi-model clients 110, 115, 120 may communicate with multi-model server 105 to obtain the load transmission graph (i.e., the publish/subscribe configuration) or portions of the load transmission graph relevant to the model hosted on the computing device. Whether the multi-model client 110, 115, 120 receives any, all, or none of the load transmission graph may be dependent on the particular publish and subscribe networking protocol used. In some embodiments, multi-model server 105 receives all published load transmissions and transmits them to the appropriate receiver (i.e., corresponding receiving node) based on the load transmission graph such that the multi-model clients 110, 115, 120 do not need or obtain the load transmission graph. Further, multi-model clients 110, 115, and 120 receive model controls including start, stop, and reset instructions from multi-model server 105 to start executing, stop executing, and reset, respectively, their models. The model controls ensure model execution is synchronized between all multi-model clients 110, 115, 120.

During execution, the data shared between the multi-model clients 110, 115, and 120 is sent and received between the multi-model clients 110, 115, and 120 using the publish and subscribe networking protocol according to the load transmission graph in substantially real-time. Depending on the publish and subscribe networking protocol used, the data representing the loads may be transmitted directly between the models or may be brokered at each transmission by multi-model server 105.

As one example depicted in FIG. 1, multi-model client 115 may publish a load (e.g., load 145) from a sending node within its model 125 to connected receiving nodes. Multi-model server 105 may receive the published load transmission and identify the corresponding receiving node(s) based on the load transmission graph. In this example, multi-model client 120 includes a corresponding receiving node in its model 130 based on the load transmission graph shown by dashed lines 140. Accordingly, multi-model server 105 may transmit the published load transmission to multi-model client 120.

An intelligent load transmission control mode is also depicted in FIG. 1. Control modes may include “unrestricted automatic,” “restricted automatic,” and “unrestricted manual.” Unrestricted automatic control mode ensures objects are sent between models automatically with no restrictions. Unrestricted manual control mode ensures objects are sent between models manually, but with no restrictions. Restricted automatic control mode ensures objects are sent only if the receiving model does not have other loads in its “congestion zone.” The congestion zone can be configured during modeling. The restricted automatic control mode is depicted in FIG. 1. Specifically, model 130 may include a congestion zone such that until load 146 is clear of the congestion zone, model 130 is not available for receiving load 145. Once the congestion zone is open, load 145 is transmitted from model 125 to model 130. To accomplish the control mode, multi-model server 105 may hold the published load transmission until model 130 is available (i.e., the congestion zone is clear). Once clear, multi-model server 105 may transmit the published load transmission to multi-model client 120.

The published load transmission is data representing a load (e.g., the product or material being created in the industrial automation process. For example, in an industrial automation process that bottles soda, the load may be a bottle. As the load moves from one area of the industrial automation process to another, it may move between models. Accordingly, data representing the load is passed between the models. The data may include shape, size, position, rotation information, quality information, and the like.

As previously discussed, the models may include one or more sending nodes and/or one or more receiving nodes. The nodes are used to send and receive data between models and convert the data to be used in the software application on the respective multi-model client 110, 115, 120. The sending node identifies an object (e.g., the material or product; also called a “load”) and deserializes it into data compatible with the publish and subscribe networking protocol. In response to deserializing the load, the sending node deletes the object and publishes the load (i.e., published load transmission). The corresponding receiving node creates the object (i.e., the load) from the data it receives by deserializing the data (i.e., the published load transmission). In some embodiments, to avoid data loss, a sending node and corresponding receiving node cannot send or receive again until both models detect the object (i.e., load).

Advantageously, system 100 allows a large-scale industrial automation process to be modeled in a distributed computing system to avoid overloading resources on a single computing device. The models communicate with each other using a publish and subscribe networking protocol that multi-model server 105 brokers to allow load transmission between the models. Further, the communications between the models happen in near-real time. Accordingly, when a sending node serializes a load, deletes the object, and publishes a load transmission, the receiving node deserializes the load, displaying the object within seconds (e.g., 1-5 seconds), making a seamless transition of loads between models to accurately depict the industrial automation process.

FIG. 2A illustrates an example dashboard user interface 200 that a user (e.g., modeler) can access on multi-model server 105. Dashboard user interface 200 includes server controls 205 and connection mapping 210. Dashboard user interface 200 may be generated by the server software application executing on multi-model server 105.

Server controls 205 includes “start server” that starts the broker service. Once started, the broker service on multi-model server 105 initiates the publish and subscribe networking protocol and connects to all registered multi-model clients 110, 115, 120. Server controls 205 also includes “stop server” that stops the broker service. Once stopped, the connections to multi-model clients 110, 115, 120 are disconnected and multi-model server 105 stops brokering communications. Server controls 205 also includes “send connections” that sets up the publish and subscribe network protocol topics automatically based on data to be transmitted between the models on multi-model clients 110, 115, and 120. For example, the load transmission graph may be shared with multi-model clients 110, 115, 120 with the send connections button. Server controls 205 also includes “delete children” that deletes client model nodes. For example, multi-model server 105 may remove specific multi-model clients 110, 115, 120 from the devices for which multi-model server 105 brokers communications. If, for example, a new multi-model client is added with a replacement model for one of the existing models, the multi-model client running the old model may be removed and the new multi-model client added to the system. Server controls 205 also includes “run model” that sends a command to each multi-model client 110, 115, and 120 to run (i.e., execute) their respective models. Run model is a model control instruction that helps ensure multi-model clients 110, 115, 120 execute their respective models substantially simultaneously. Server controls 205 also includes “stop model” that sends a command to each multi-model client 110, 115, and 120 to stop running their respective models. Stop model is also a model control instruction that helps ensure multi-model clients 110, 115, 120 execute their respective models substantially simultaneously. Server controls 205 also includes “reset model” that sends a command to each multi-model client 110, 115, and 120 to reset their respective models. Reset model is also a model control instruction that helps ensure multi-model clients 110, 115, 120 execute their respective models substantially simultaneously. The user can click or otherwise indicate the command functions to perform the corresponding command.

Connections mapping 210 includes a block diagram representation of the model hosted by each multi-model client and the corresponding configured sending and receiving nodes. When one of the multi-model clients 110, 115, 120 register with multi-model server 105, multi-model server 105 ingests model information including the sending and receiving nodes of the respective model. During modeling (discussed in more detail with respect to FIG. 10), the load transmission graph is configured. Connections mapping 210 depicts the existing models, their sending and receiving nodes, and the corresponding load transmission graph information. For example, model 212 represents a first model executing on a first multi-model client (e.g., multi-model client 110). Model 212 has four sending nodes 218a-218d. Model 212 may be called a sending component since it has only sending nodes, in some embodiments. Model 214 represents a second model executing on a second multi-model client (e.g., multi-model client 115). Model 214 has four receiving nodes 220a-220d and four sending nodes 222a-222d. Model 214 may be called a sending/receiving component since it has both sending nodes and receiving nodes. Model 216 represents a third model executing on a third multi-model client (e.g., multi-model client 120). Model 216 has four receiving nodes 224a-222d. As depicted in FIG. 2, sending node 218a is coupled to receiving node 220a, which forms one connection in the load transmission graph. Similarly, sending node 222a is coupled to receiving node 224a, which forms another connection in the load transmission graph. In this way, an object (e.g., a load, a product, a widget, material) movement from model 212 to model 214 and on to model 216 can be simulated or emulated in real-time.

FIG. 2B illustrates system 100 having the configuration depicted by the dashboard user interface 200. In particular, model 212 hosted on multi-model client 110 includes four sending nodes 218a-218d that transmit to four receiving nodes 220a-220d, respectively, in model 214 hosted on multi-model client 115. The load transmission graph is depicted by dashed lines 140, and this particular set of connections are depicted by dashed line 140a. Similarly, model 214 hosted on multi-model client 115 includes four sending nodes 222a-222d that transmit to four receiving nodes 224a-224d, respectively, in model 216 hosted on multi-model client 120. This set of connections are depicted in the load transmission graph by dashed line 140b.

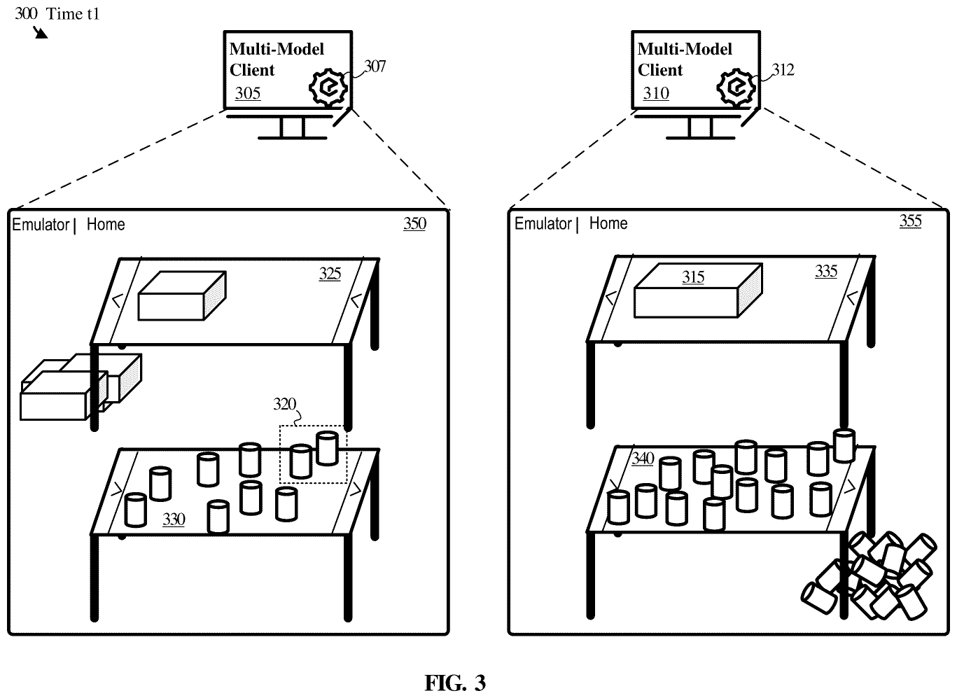

FIG. 3 illustrates a visualization 300 of an example of two models each representing a portion of an industrial automation system sharing data in real time at time t1. Multi-model client 305 includes digital twin 307 (i.e., model) of a first portion of the industrial automation process shown in user interface 350. Multi-model client 310 includes digital twin 312 of a second portion of the industrial automation process shown in user interface 355. The control mode for this example is unrestricted automatic, so the loads (e.g., products, material, etc.) are passed from one model to the other automatically without restriction. Multi-model client 305, which may be the same as multi-model client 110 described in FIG. 1, is hosting digital twin 307, which includes one receiving node, associated with conveyor 325, and one sending node, associated with conveyor 330. Multi-model client 310, which may be the same as multi-model client 115, is hosting digital twin 312, which includes one receiving node, associated with conveyor 340, and one sending node, associated with conveyor 335. At time t1, captured by this screen shot of user interfaces 350, 355, the simulation visualization of digital twin 312 includes load 315 on conveyor 335. Further, at time t1, the simulation visualization of digital twin 307 includes a set of loads 320, which are shown as two cans, on conveyor 330. While not explicitly shown, the load transmission graph of this system includes a connection between the sending node associated with conveyor 330 of digital twin 307 and the receiving node associated with conveyor 340 of digital twin 312. The load transmission graph further includes a connection between the sending node associated with conveyor 335 of digital twin 312 and the receiving node associated with conveyor 325 of digital twin 307.

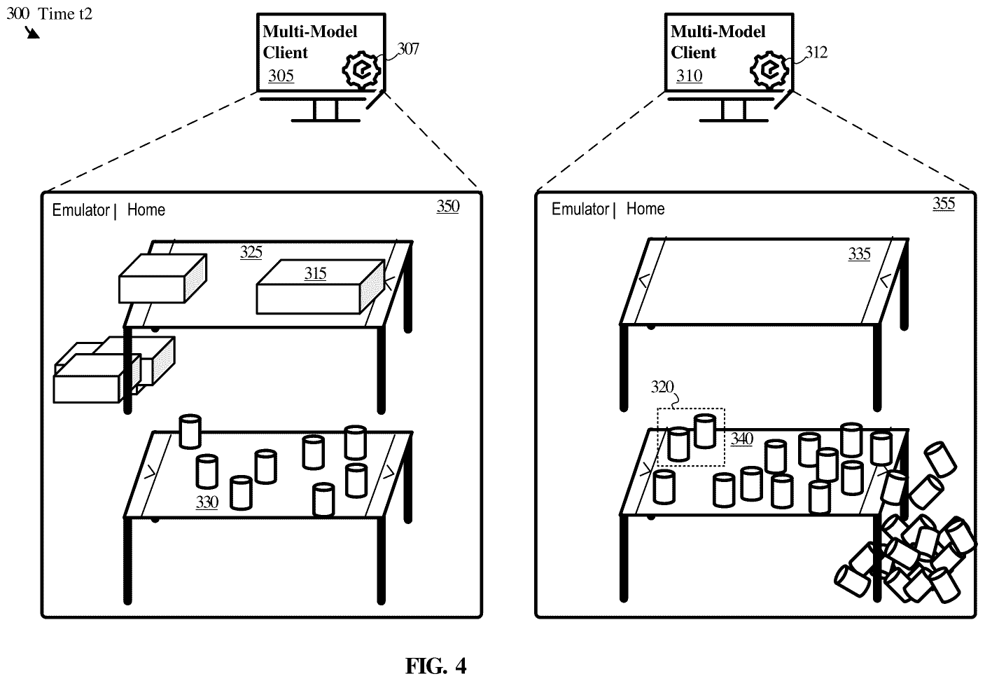

FIG. 4 illustrates the visualization 300 at time t2. At time t2, load 315 has been transmitted from digital twin 312 to digital twin 307 and is now represented in user interface 350 on multi-model client 305. Also, load 320 has been transmitted from digital twin 307 to digital twin 312 and is now represented in user interface 355 on multi-model client 310.

In digital twin 312, when load 315 reached the end of conveyor 335, which represents the sending node associated with conveyor 335, digital twin 312 deserialized load 315, and published load 315 as a published load transmission. The multi-model server (e.g., multi-model server 105) received the published load transmission and immediately transmitted it to the receiving node associated with conveyor 325, which is in digital twin 307 hosted by multi-model client 305. Upon receipt, digital twin 307 deserialized the published load transmission and generated the object, which appears as load 315 in user interface 350. Load 320 is similarly serialized by digital twin 307 and transmitted via the multi-model server to digital twin 312, which deserializes the published load transmission (e.g., load data) to generate the object (i.e., load 320), which is shown in user interface 355 on conveyor 340. While load 320 represents two products, any number or volume of products may be represented by a load. For ease of visualization in this example, two cans are represented by load 320, though often a single product represents one load. The control mode represented in visualization 300 is unrestricted automatic, meaning that the multi-model server transmits the published load transmission without restriction to the corresponding receiving nodes. Further, the digital twins 307, 312 automatically publish the load transmissions immediately upon the load reaching the sending node location within the digital twin.

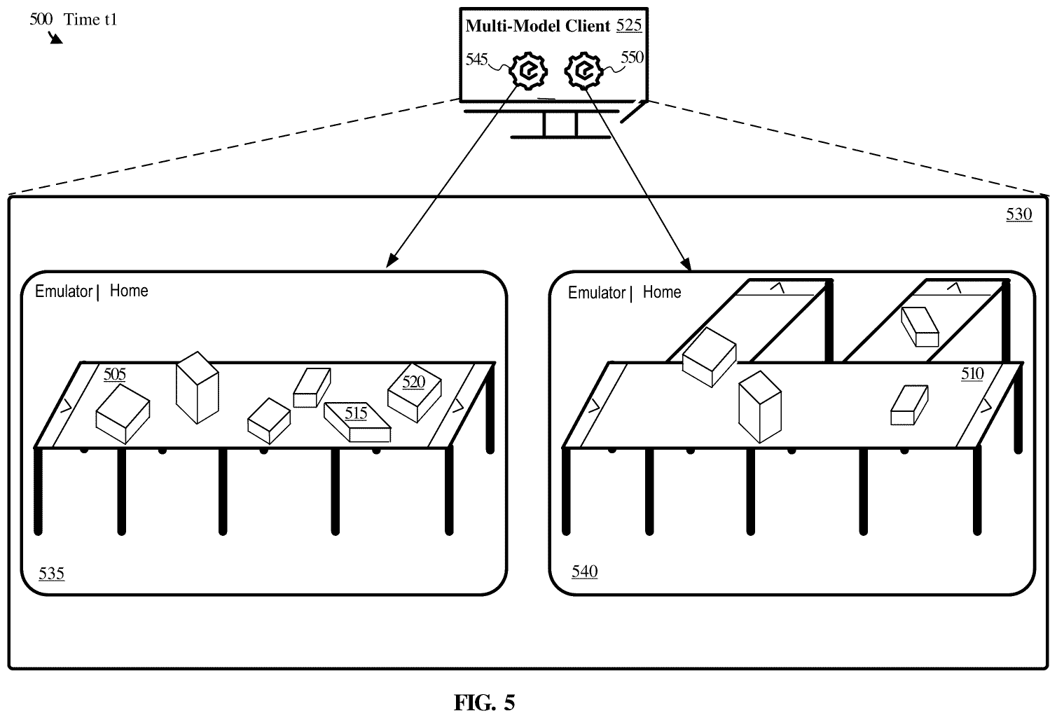

FIG. 5 illustrates a visualization 500 of another example of two models each representing a portion of an industrial automation process sharing data in real time at time t1. Multi-model client 525 includes digital twin 545 of a first portion of the industrial automation process and digital twin 550 of a second portion of the industrial automation process. In some embodiments, multi-model client 525 hosts digital twin 545 in a first virtual machine and digital twin 550 in a second virtual machine. Screen 530 shows user interface 535 associated with digital twin 545 and user interface 540 associated with digital twin 550. Digital twin 545 includes conveyor 505, which has an associated sending node (not shown). Digital twin 550 includes conveyor 510, which has an associated receiving node (not shown). At time t1, as shown in user interface 535, load 515 and load 520 are represented in the simulation visualization of digital twin 545 on conveyor 505. The control mode for this example is unrestricted manual, so the user may manually move loads (e.g., products, material, widgets, etc.) from one model to the other without restriction. For example, the user may click and drag the load to move it to the sending node (i.e., the end of the conveyor) for transmission. In some embodiments, once the load reaches the end of the conveyor, the user may click the load to initiate the publication of the load. Upon clicking the load to indicate that the load should be published, digital twin 545 serializes the object representing the load (e.g., load 515, 520) and publishes the load transmission.

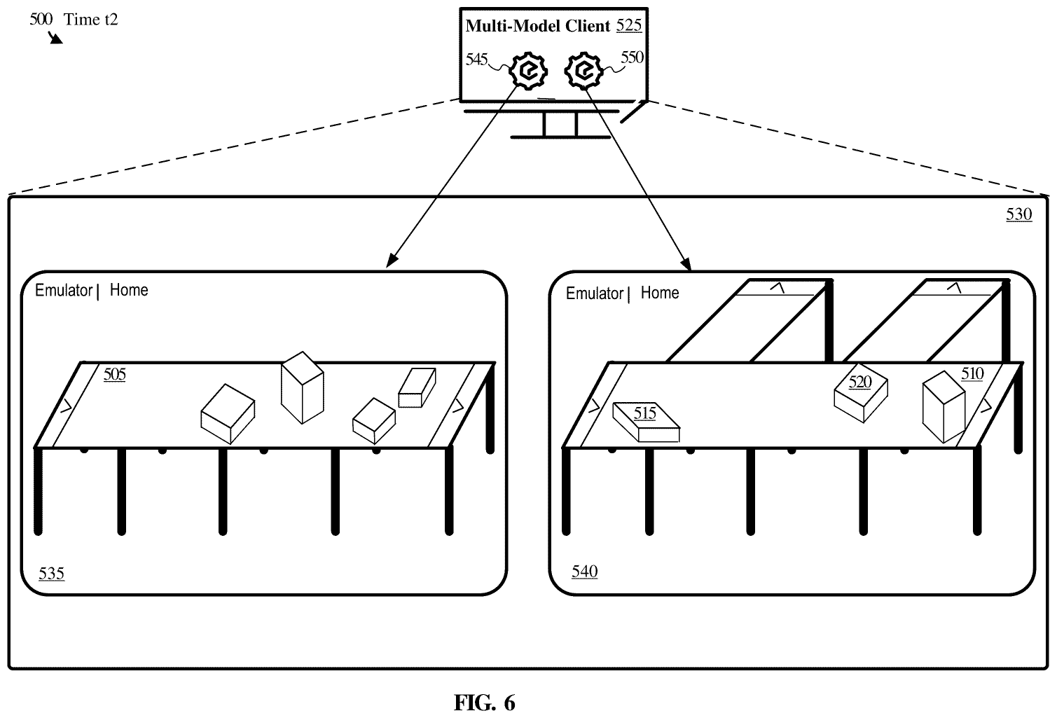

FIG. 6 illustrates the visualization 500 at time t2. Upon receipt of the published load transmission from the multi-model server, digital twin 550 deserializes the loads and generates the object, showing the objects in user interface 540. As depicted, load 520 is further down conveyor 510 than load 515, indicating there was a delay between the user manually transmitting load 515 after load 520. Note that the positioning of each of the loads is the same. In other words, at time t1, load 515 was sitting on conveyor 505 at an angle rather than straight and load 520 was sitting on conveyor 505 at a second angle rather than straight. At time t2, the loads 515, 520 are still sitting at their respective angles on conveyor 510. Accordingly, data specific to each load or object and representing various parameters or attributes of the load or object can be transmitted between models. This information is incorporated when the sending node serializes the object for publishing the load transmission. When the receiving node receives the load transmission, deserializing the object, including all relevant information which may include many attributes associated with the load. In addition to position, color, size, shape, quality, and any other relevant parameter may be included.

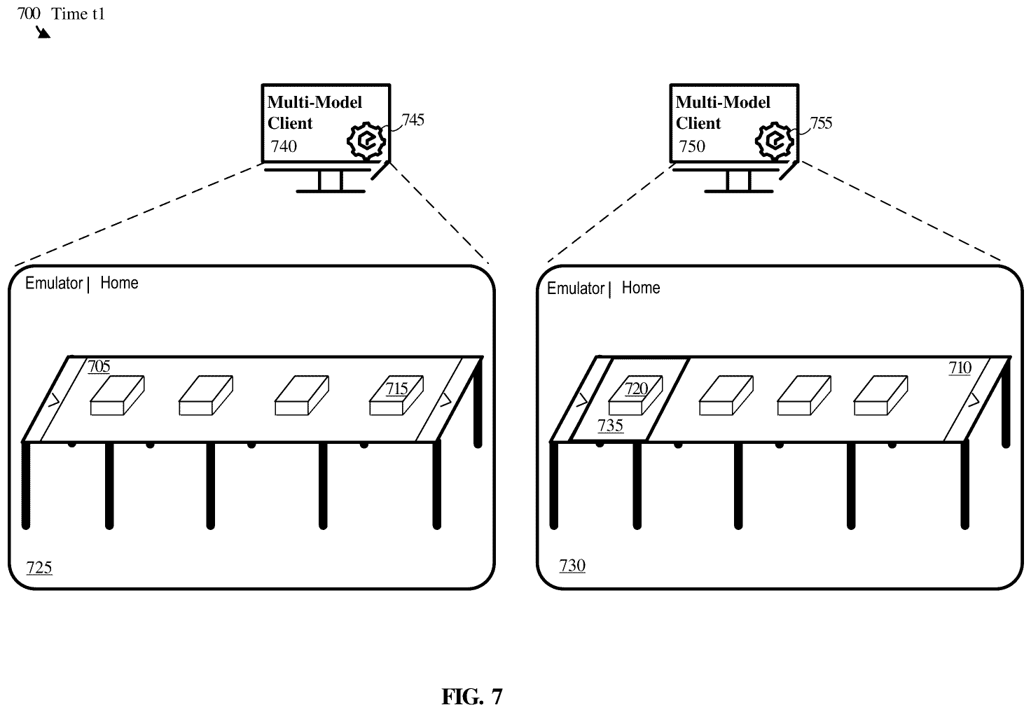

FIG. 7 illustrates a visualization 700 of another example of two models each representing a portion of an industrial automation system sharing data in real time at time t1.

Multi-model client 740 hosts digital twin 745 represented in user interface 725. Multi-model client 750 hosts digital twin 755 represented in user interface 730. Conveyor 705 is associated with a sending node in digital twin 745, and conveyor 710 is associated with a receiving node in digital twin 755. Conveyor 710 includes congestion zone 735, and the control mode for this system is automatic restricted. Accordingly, loads cannot be transmitted from the sending node in digital twin 745 to the receiving node in digital twin 755 unless congestion zone 735 is clear of loads. At time t1, load 715 is represented in digital twin 745 near the sending node of conveyor 705. At time t1, load 720 is represented in digital twin 755 in congestion zone 735 of conveyor 710. Since the control mode for this example is restricted automatic, loads will not transfer from the sending node to the receiving node when there is a load in the congestion zone.

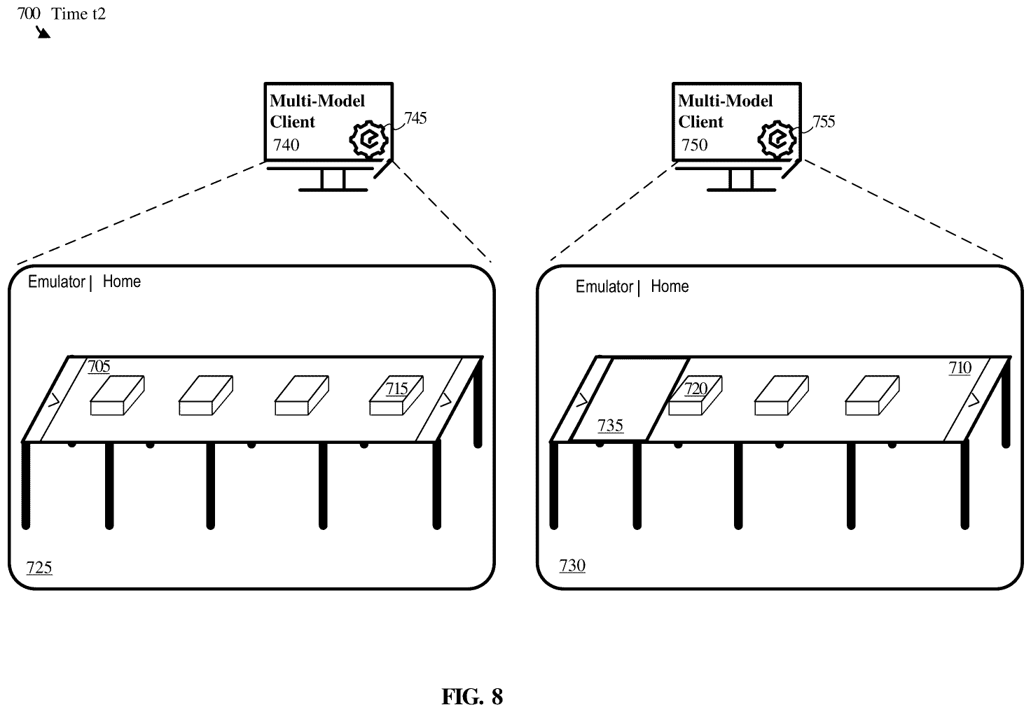

FIG. 8 illustrates the visualization 700 at time t2. Load 720 has just cleared congestion zone 735, making room for receipt of load 715. Upon congestion zone 735 being clear, load 715 is published. In some embodiments, multi-model server (e.g., multi-model server 105) holds the published load transmission until congestion zone 735 is clear. Upon confirming congestion zone 735 is clear, the multi-model server publishes the load to the receiving node of digital twin 755 and notifies digital twin 745 of the transmission. In this way, digital twin 745 may not delete the object representing load 715 until it receives notification of the transmission, and digital twin 755 does not receive the load until congestion zone 735 is clear. Other methods of notification may be used to ensure that load 715 is continuously represented in one of digital twin 745 or 755 continuously.

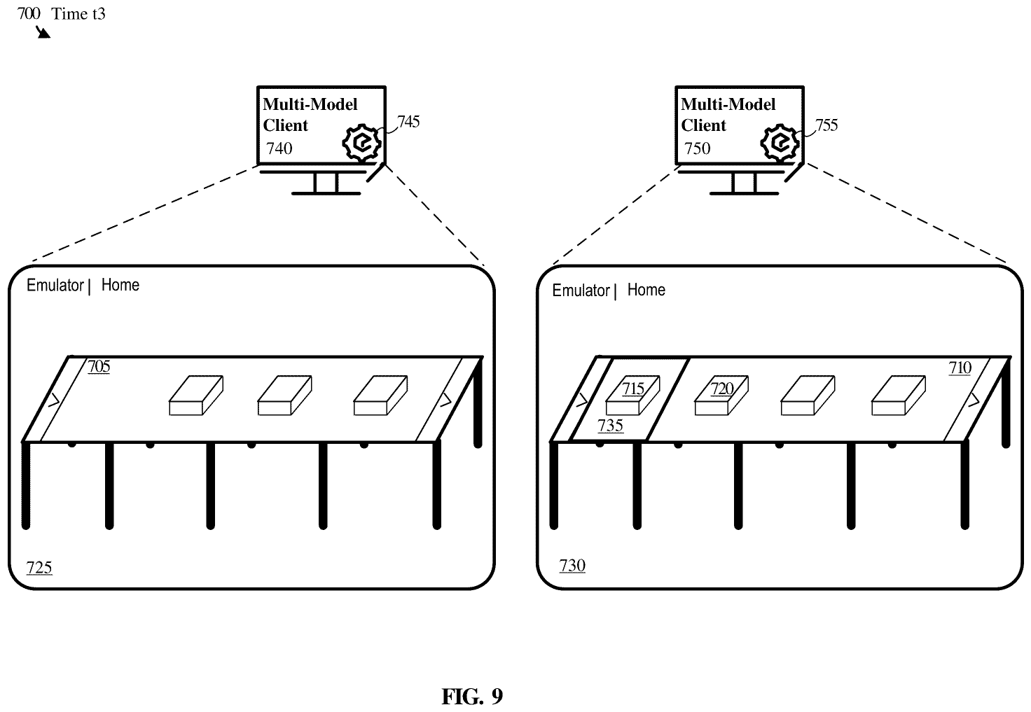

FIG. 9 illustrates the visualization 700 at time t3. At time t3, multi-model server has confirmed or detected clearing of congestion zone 735, and load 715 is transmitted from the sending node in digital twin 745 to the receiving node in digital twin 755. As previously discussed, load 715 is serialized by digital twin 745 and published, but the object representing load 715 may not be deleted and removed from the visualization in user interface 725 until notification from multi-model server is received. In some embodiments, multi-model server may stop digital twin 745 from serializing the object and publishing the load transmission until congestion zone 735 is clear, ensuring that if the delay is too long, a buildup of loads on conveyor 705 may be properly detected.

FIG. 10 illustrates an example user interface 1000 including a design dashboard 1005 for configuring the load transmission graph. User interface 1000 is generated on the multi-model server (e.g., multi-model server 105) brokering the system. The presently depicted configuration is creating the load transmission graph from sending node 1010 of digital twin 745 (see FIGS. 7-9) to the receiving node 1015 of digital twin 755. When multi-model clients 740 and 750 register with the multi-model server, relevant information for their respective digital twins 745 and 755 are provided to the multi-model server. For digital twin 745, the sending node 1010 and some of its configuration information including an associated name and the like are provided. Accordingly, digital twin 745 can be represented as a block in the block diagram depicted, which can be moved and connections can be formed. Specifically, as shown in FIGS. 7-10, sending node 1010 can be connected to receiving node 1015 as one link in the load transmission graph.

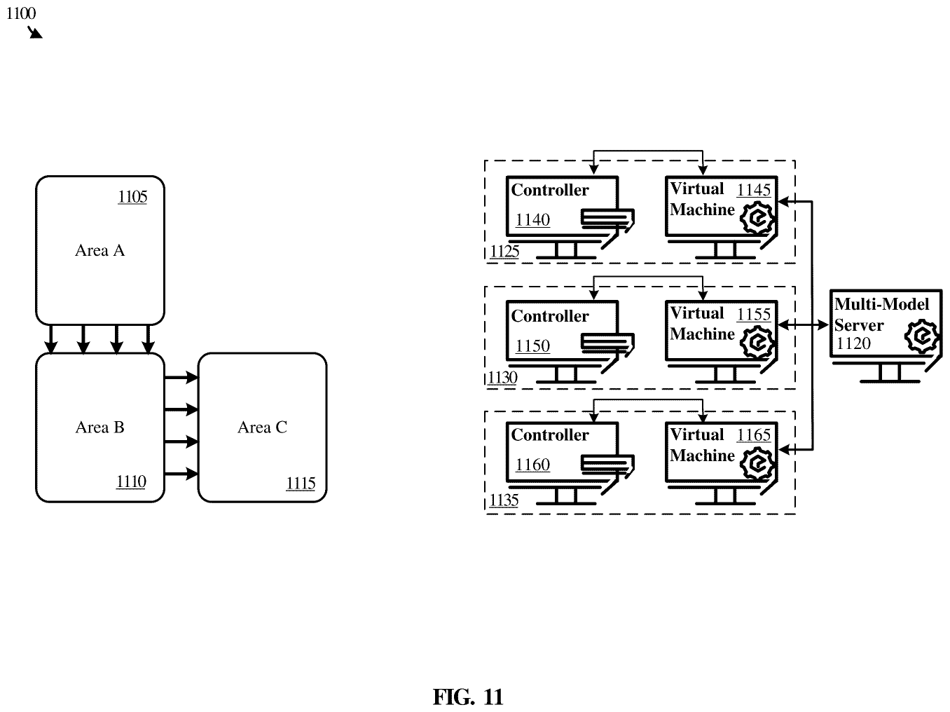

FIG. 11 illustrates an example architecture 1100 for an industrial automation process including area A 1105, area B 1110, and area C 1115. Material (e.g., loads) moves from area A 1105 to area B 1110 and from area B 1110 to area C 1115. Architecture 1100 includes multi-model server 1120, which may be the same as multi-model server 105. Architecture 1100 further includes three multi-model clients 1125, 1130, and 1135. Multi-model client 1125 runs controller 1140 that runs emulation software such as ROCKWELL's FACTORY TALK LOGIX ECHO. Multi-model client 1130 includes controller 1150 that runs the emulation software, and multi-model client 1135 includes controller 1160 that runs the emulation software. Further, multi-model client 1125 runs virtual machine 1145 that includes the digital twin representing area A 1105. Multi-model client 1130 runs virtual machine 1155 that includes the digital twin representing area B 1110. Multi-model client 1135 runs virtual machine 1165 that includes the digital twin representing area C 1115. Multi-model clients 1125, 1130, and 1135 may be the same as multi-model clients 110, 115, and 120 described with respect to FIG. 1.

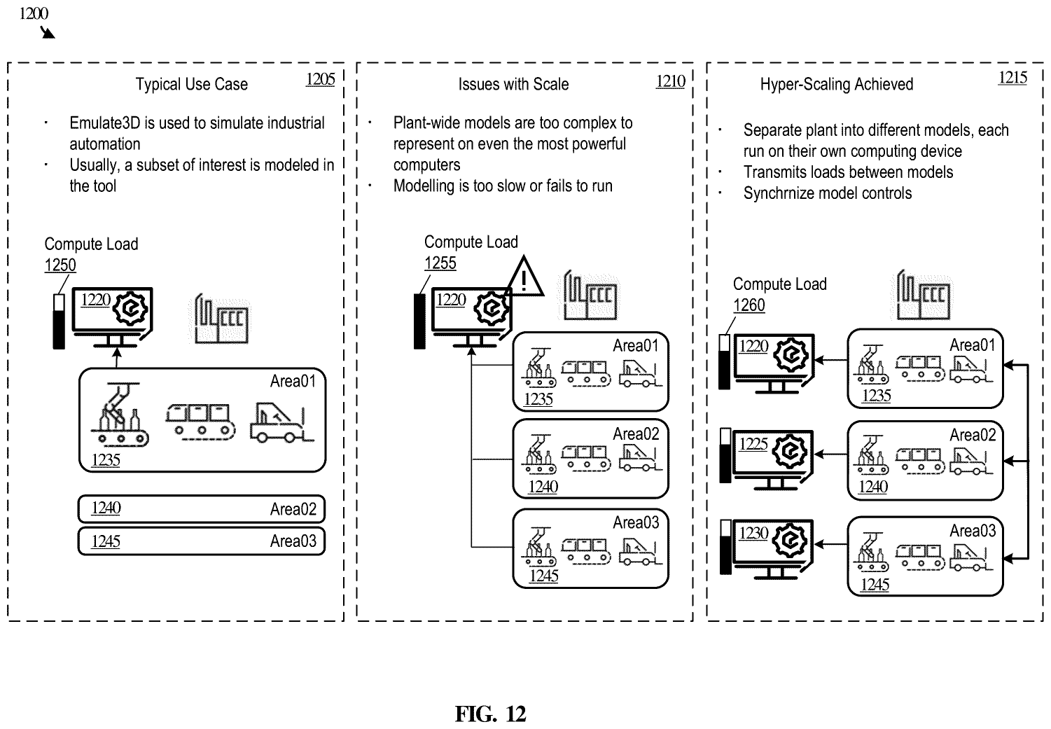

FIG. 12 illustrates a view 1200 of use cases and issues with scaling. In the typical use case 1205, an emulation or simulation software such as ROCKWELL's EMULATE3D is used to simulate a subset of the industrial automation environment. The computing system has enough computing power to simulate only a portion of the system that is of interest. As shown in view 1200, the area of interest may be Area01 1235. When only Area01 1235 is simulated by multi-model client 1220, compute load 1250 remains acceptable.

There are issues when the industrial automation process becomes too large such that the areas of interest exceed the computing power of multi-model client 1220. This is shown in issues with scale 1210. This particularly comes into play when large (e.g., plant-wide) models need to be simulated. Such models are too complex to properly simulate on a single machine in a digital twin environment that needs real-time simulation. The model may be too slow or fail to run because the computing power of the machine is insufficient to simulate the entire system. As shown in issues with scale 1210, multi-model client 1220 cannot simulate Area01 1235, Area02 1240, and Area03 1245 simultaneously because compute load 1255 is exceeded.

Hyper-scaling is achieved 1215 using system 100 described above. The plant can be separated into portions, such as by physical area, and each area model is simulated on a separate multi-model client. In the example shown, the digital twin for Area01 1235 is run by multi-model client 1220, the digital twin for Area02 1240 is run by multi-model client 1225, and the digital twin for Area03 1245 is run by multi-model client 1230. The digital twins on each multi-model client are synchronized by the multi-model server (e.g., multi-model server 105). In this way, data and loads are transmitted between the models for simulation of the entire system in substantially real time, and there is sufficient compute power to execute the models simultaneously because it is distributed across multiple computing systems.

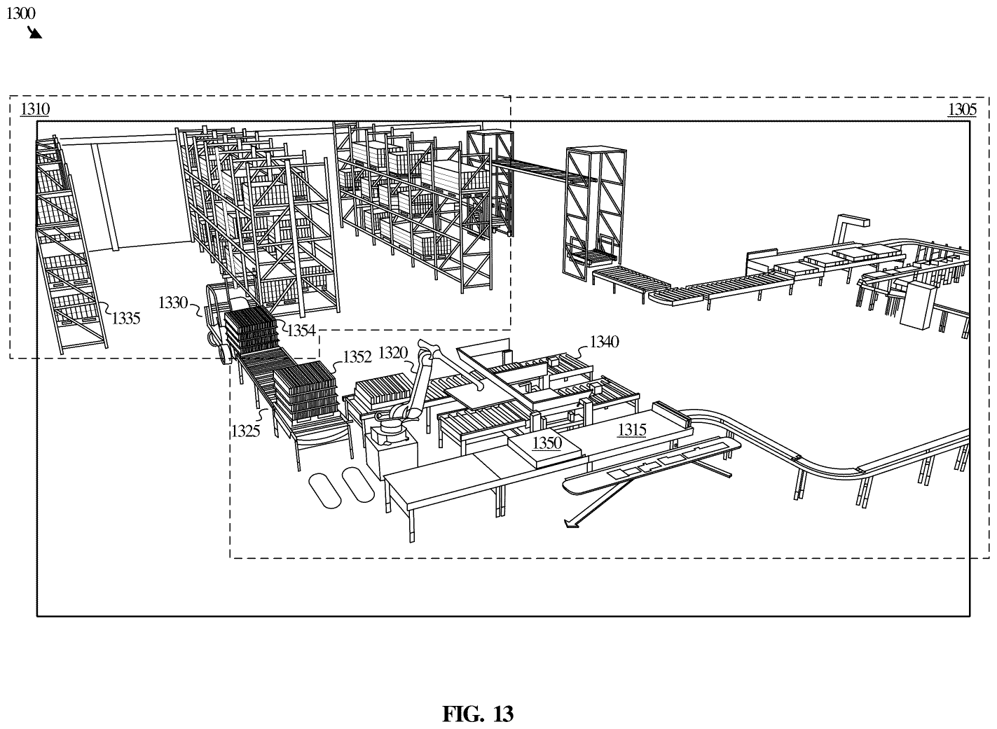

FIG. 13 illustrates an example depiction of an industrial automation process 1300 that is too large to simulate on a single multi-model client. However, industrial automation process 1300 can be broken into portions and represented in separate digital twins for each portion. As shown, industrial automation process 1300 can be separated into Area01 1305 and Area02 1310. Loads (e.g., loads 1350, 1352) move on conveyor 1315 into reach of machine 1320. Machine 1320 moves the loads from conveyor 1315 to conveyor 1325, sometimes halting at conveyor 1340 waiting for space on conveyor 1325. The loads 1350, 1352 may represent any material including pallets of products, single products, and the like.

Once on conveyor 1325, forklift 1330 moves the loads from conveyor 1325 to storage shelves 1335.

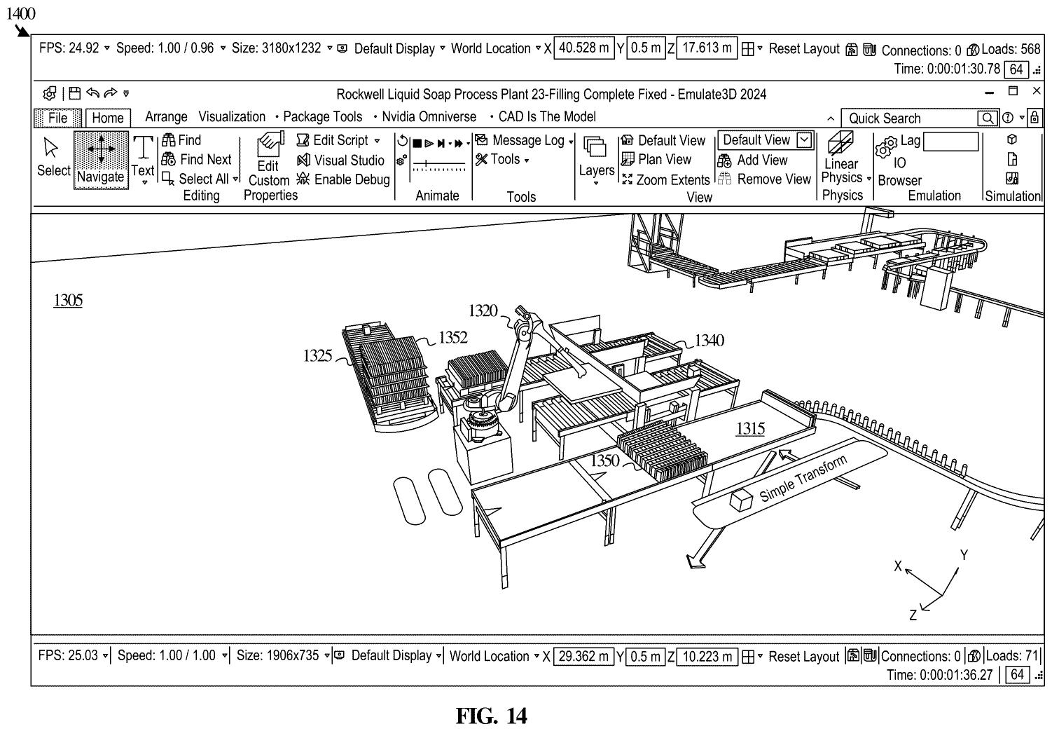

FIG. 14 illustrates user interface 1400 depicting a digital twin of Area01 1305 simulated on a first multi-model client (e.g., multi-model client 110). As seen, the first half of conveyor 1325 holds loads (e.g., loads 1350, 1352) and functions as a sending node of this digital twin.

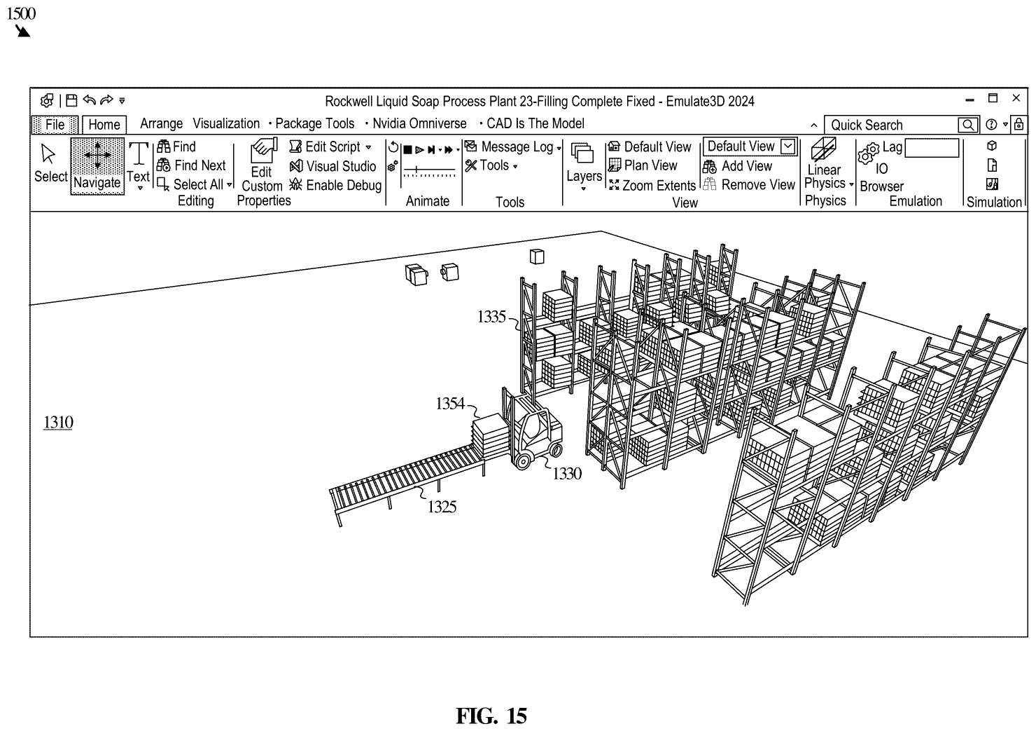

FIG. 15 illustrates user interface 1500 depicting a digital twin of Area02 1310 simulated on a second multi-model client (e.g., multi-model client 115). As seen, the second half of conveyor 1325 appears in this digital twin and functions as the receiving node of this digital twin.

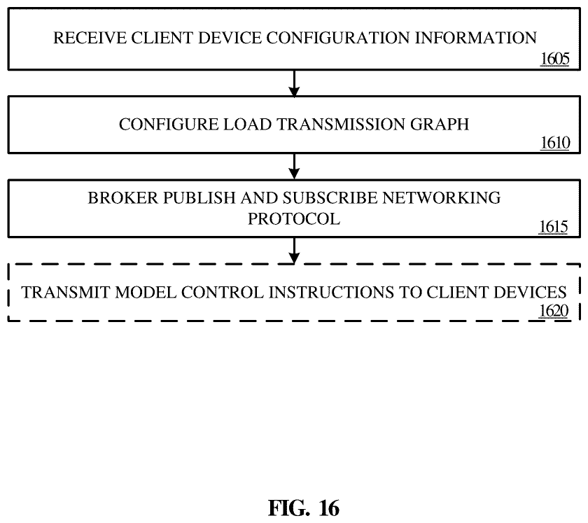

FIG. 16 illustrates a method 1600 for synchronizing distributed models for industrial automation processes. Method 1600 may be performed by multi-model server 105 as discussed in detail in FIG. 1. While specific steps are indicated in method 1600, the steps may not all be performed or performed in the order indicated in some embodiments.

Method 1600 begins with step 1605 in which multi-model server (e.g., multi-model server 105) receives multi-model client configuration information. For example, multi-model clients 110, 115, and 120 may register as part of system 100 with multi-model server 105. Upon registering as nodes of the publish and subscribe networking protocol, information about the models hosted by the respective multi-model clients may be provided to the multi-model server. Multi-model server 105 may ingest the configuration information, including information about the sending nodes and receiving nodes included in the models.

At step 1610, the multi-model server may generate a user interface including the configuration information from the multi-model clients to allow the user to select configuration options to configure the load transmission graph. The load transmission graph may include the connections between sending nodes and corresponding receiving nodes for transmitting loads between models on the distributed multi-model clients. In some embodiments, the multi-model server generates a user interface such as dashboard 1000 of FIG. 10 and uses the input received via dashboard 1000 to generate the load transmission graph.

At step 1615, the multi-model server may serve as the communication broker for the publish and subscribe networking protocol. For example, loads transmitted from a sending node are received by the multi-model server and transmitted to the corresponding receiving node based on the load transmission graph.

At step 1620, which is optional, the multi-model server transmits model control instructions to the multi-model clients. For example, the multi-model server may transmit a run instruction so all models in the system are executed substantially simultaneously. Similarly, stop instructions and reset instructions can be sent to the multi-model clients to stop or reset (respectively) the models hosted on the multi-model clients substantially simultaneously. Using the model control instructions and the connection brokering by the multi-model server, the system makes distributed, synchronized digital twins of industrial automation processes possible.

FIG. 17 illustrates computing system 1705 that may represent a server computing machine or a client computing machine executing the simulation or emulation software as described in more detail with respect to FIGS. 1-16. Computing system 1705 is representative of any system or collection of systems with which the various operational architectures, processes, scenarios, and sequences disclosed herein for implementation of a digital twin modeling system in an industrial automation environment may be employed. Computing system 1705 may be implemented as a single apparatus, system, or device or may be implemented in a distributed manner as multiple apparatuses, systems, or devices. Computing system 1705 includes, but is not limited to, processing system 1725, storage system 1710, software 1715, communication interface system 1720, and user interface system 1730 (optional). Processing system 1725 is operatively coupled with storage system 1710, communication interface system 1720, and user interface system 1730. Computing system 1705 may be representative of a cloud computing device, distributed computing device, or the like.

Processing system 1725 loads and executes software 1715 from storage system 1710. Software 1715 includes and implements simulation/emulation software 1735, which is representative of any of the simulation or emulation systems described in the preceding figures. When executed by processing system 1725 to provide emulation or simulation in digital twin environments, software 1715 directs processing system 1725 to operate as described herein for at least the various processes, operational scenarios, and sequences discussed in the foregoing implementations. Computing system 1705 may optionally include additional devices, features, or functionality not discussed for purposes of brevity.

Processing system 1725 may comprise a microprocessor and other circuitry that retrieves and executes software 1715 from storage system 1710. Processing system 1725 may be implemented within a single processing device but may also be distributed across multiple processing devices or sub-systems that cooperate in executing program instructions. Examples of processing system 1725 include general purpose central processing units, graphical processing units, application specific processors, and logic devices, as well as any other type of processing device, combinations, or variations thereof.

Storage system 1710 may comprise any computer readable storage media readable by processing system 1725 and capable of storing software 1715. Storage system 1710 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1710 may also include computer readable communication media over which at least some of software 1715 may be communicated internally or externally. Storage system 1710 may be implemented as a single storage device but may also be implemented across multiple storage devices or sub-systems co-located or distributed relative to each other. Storage system 1710 may comprise additional elements, such as a controller capable of communicating with processing system 1725 or possibly other systems.

Software 1715 (including simulation/emulation software 1735) may be implemented in program instructions and among other functions may, when executed by processing system 1725, direct processing system 1725 to operate as described with respect to the various operational scenarios, sequences, and processes illustrated herein. For example, software 1715 may include program instructions for implementing portions of the simulation/emulation system as described herein. For example, software 1715 may include software for implementing the simulation or emulation software on a client or server computing system as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1715 may include additional processes, programs, or components, such as operating system software, virtualization software, or other application software. Software 1715 may also comprise firmware or some other form of machine-readable processing instructions executable by processing system 1725.

In general, software 1715 may, when loaded into processing system 1725 and executed, transform a suitable apparatus, system, or device (of which computing system 1705 is representative) overall from a general-purpose computing system into a special-purpose computing system customized to simulate or emulate industrial automation systems in a digital twin environment utilizing the data orchestration between simulation or emulation models on each machine. Indeed, encoding software 1715 on storage system 1710 may transform the physical structure of storage system 1710. The specific transformation of the physical structure may depend on various factors in different implementations of this description. Examples of such factors may include, but are not limited to, the technology used to implement the storage media of storage system 1710 and whether the computer-storage media are characterized as primary or secondary storage, as well as other factors.

For example, if the computer readable storage media are implemented as semiconductor-based memory, software 1715 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1720 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1705 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of distributed emulation model synchronization, the method comprising:
configuring a load transmission graph comprising a link between a sending node and a receiving node, wherein the sending node is hosted in a first emulation model on a first multi-model client and the receiving node is hosted in a second emulation model on a second multi-model client; and
brokering a publish and subscribe networking protocol to receive published load transmissions from the sending node and transmit the published load transmissions to the receiving node based on the load transmission graph.

2. The method of claim 1, further comprising:
generating a first user interface that displays an execution of the first emulation model; and
generating a second user interface that displays an execution of the second emulation model synchronized with the execution of the first emulation model.

3. The method of claim 2, wherein:
the first user interface is displayed on the first multi-model client;
the second user interface is displayed on the second multi-model client; and
upon transmission of a load, the load is visually removed from the first user interface and visually added to the second user interface.

4. The method of claim 1, wherein the first emulation model is a first digital twin of a first portion of an industrial automation process and the second emulation model is a second digital twin of a second portion of the industrial automation process.

5. The method of claim 1, further comprising:
transmitting model control instructions to the first multi-model client and the second multi-model client simultaneously to synchronize execution of the first emulation model and the second emulation model, wherein the model control instructions comprise a run instruction, a stop instruction, and a reset instruction.

6. The method of claim 1, further comprising:
receiving a first published load transmission of a first load from the sending node, wherein the sending node publishes the first load in response to serializing the first load in the first emulation model; and
transmitting the first published load transmission of the first load to the receiving node, wherein the receiving node deserializes the first load in the second emulation model upon receiving the first published load transmission.

7. The method of claim 1, further comprising:
receiving configuration information from each of the first multi-model client and the second multi-model client, wherein the configuration information includes information corresponding to the sending node and information corresponding to the receiving node; and
generating a graphical user interface comprising a configuration dashboard based on the configuration information, wherein the configuring the load transmission graph is based on user input received via the configuration dashboard.

8. The method of claim 1, wherein:
the first multi-model client and the second multi-model client are multi-model clients of a plurality of multi-model clients of the publish and subscribe networking protocol;
each multi-model client of the plurality of multi-model clients hosts an emulation model of a plurality of emulation models including the first emulation model and the second emulation model;
each of the plurality of emulation models comprises a digital twin of a portion of an industrial automation process;
the load transmission graph comprises a plurality of sending nodes including the sending node and a plurality of receiving nodes including the receiving node; and
each of the plurality of emulation models comprise one or more of a sending node of the plurality of sending nodes, one or more of a receiving node of the plurality of receiving nodes, or a combination thereof.

9. The method of claim 1, further comprising:
receiving a first published load transmission of a first load from the sending node;
holding the first published load transmission until a congestion zone in the second emulation model is clear of previous loads; and
upon confirmation that the congestion zone is clear, transmitting the first published load transmission of the first load to the receiving node.

10. A system for synchronizing distributed emulation models, the system comprising:
one or more processors; and
one or more memories having stored thereon instructions that, upon execution by the one or more processors, cause the one or more processors to:
configure a load transmission graph comprising a link between a sending node and a receiving node, wherein the sending node is hosted in a first emulation model on a first multi-model client and the receiving node is hosted in a second emulation model on a second multi-model client, and
broker a publish and subscribe networking protocol to receive published load transmissions from the sending node and transmit the load transmission to the receiving node based on the load transmission graph.

11. The system of claim 10, wherein the instructions comprise further instructions that, upon execution by the one or more processors, cause the one or more processors to:
transmit model control instructions to the first emulation model and the second emulation model simultaneously to synchronize execution, wherein the model control instructions comprise a run instruction, a stop instruction, and a reset instruction.

12. The system of claim 10, wherein the first emulation model is a first digital twin of a first portion of an industrial automation process and the second emulation model is a second digital twin of a second portion of the industrial automation process.

13. The system of claim 10, wherein the instructions comprise further instructions that, upon execution by the one or more processors, cause the one or more processors to:
receive a first published load transmission of a first load from the sending node, wherein the sending node publishes the first load in response to serializing the first load in the first emulation model; and
transmit the first published load transmission of the first load to the receiving node, wherein the receiving node deserializes the first load in the second emulation model upon receiving the first published load transmission.

14. The system of claim 10, wherein the instructions comprise further instructions that, upon execution by the one or more processors, cause the one or more processors to:
receive configuration information from each of the first multi-model client and the second multi-model client, wherein the configuration information includes information corresponding to the sending node and information corresponding to the receiving node; and
generate a graphical user interface comprising a configuration dashboard based on the configuration information, wherein the instructions to configure the load transmission graph is based on user input received via the configuration dashboard.

15. The system of claim 10, wherein:
the first multi-model client and the second multi-model client are multi-model clients of a plurality of multi-model clients of the publish and subscribe networking protocol;
each multi-model client of the plurality of multi-model clients hosts an emulation model of a plurality of emulation models including the first emulation model and the second emulation model;
each of the plurality of emulation models comprises a digital twin of a portion of an industrial automation process;
the load transmission graph comprises a plurality of sending nodes including the sending node and a plurality of receiving nodes including the receiving node; and
each of the plurality of emulation models comprise one or more of a sending node of the plurality of sending nodes, one or more of a receiving node of the plurality of receiving nodes, or a combination thereof.

16. The system of claim 10, wherein the instructions comprise further instructions that, upon execution by the one or more processors, cause the one or more processors to:
receive a first published load transmission of a first load from the sending node;
hold the first published load transmission until a congestion zone in the second emulation model is clear of previous loads; and
upon confirmation that the congestion zone is clear, transmit the first published load transmission of the first load to the receiving node.

17. A synchronized, distributed digital twin system, comprising:
a plurality of multi-model clients of a publish and subscribe networking protocol, wherein each multi-model client is configured to:
register with a broker device of the publish and subscribe networking protocol, host a digital twin of a portion of an industrial automation system; and
the broker device of the publish and subscribe networking protocol, wherein the broker device is configured to:
configure a load transmission graph comprising links between sending nodes and receiving nodes, wherein the sending nodes and corresponding receiving nodes are distributed across the digital twins hosted on different of the plurality of multi-model clients; and
broker the publish and subscribe networking protocol to receive published load transmissions from the sending nodes and transmit the load transmissions to the corresponding receiving nodes based on the load transmission graph.

18. The system of claim 17, wherein each multi-model client of the plurality of multi-model clients are further configured to:
publish load transmissions for sending nodes of the digital twin hosted by the respective multi-model client;
receive load transmissions for receiving nodes of the digital twin hosted by the respective multi-model client; and
generate a graphical user interface depicting a visualization of the digital twin hosted by the respective multi-model client, wherein:
upon publishing a load transmission, the published load is visually removed from the graphical user interface, and
upon receiving a load transmission, the received load is visually added to the graphical user interface.

19. The system of claim 17, wherein each multi-model client of the plurality of multi-model clients are further configured to:
publish load transmissions for sending nodes of the digital twin hosted by the respective multi-model client;
upon publishing a load transmission, deserializing the published load in the digital twin;
receive load transmissions for receiving nodes of the digital twin hosted by the respective multi-model client; and
upon receiving a load transmission, serializing the received load in the digital twin.

20. The system of claim 17, wherein:
the broker device is further configured to transmit model control instructions to the plurality of multi-model clients simultaneously to synchronize execution of the digital twins, wherein the model control instructions comprise a run instruction, a stop instruction, and a reset instruction; and
each multi-model client of the plurality of multi-model clients are further configured to, upon receipt of a model control instruction, execute the model control instruction on the digital twin of the respective multi-model client.
